(19) United States
(12) Patent Application Publication
(10) Pub. No.: US 2006/0266705 A1
(43) Pub. Date: Nov. 30, 2006

(54) Refreshing chemicals during membrane cleaning

(76) Inventors: Arnold Janson, Burlington (CA); Nicholas William Harcsar Adams, Hamilton (CA)

Correspondence Address: BERESKIN AND PARR, 40 KING STREET WEST, BOX 401, TORONTO, ON, M5H 3Y2, CA

(21) Appl. No.: 11/405,506

(22) Filed: Apr. 18, 2006

Related U.S. Application Data
(60) Provisional application No. 60/673,763, filed on Apr. 22, 2005.

(51) Int. Cl. B01D 65/02

(52) U.S. Cl. 210/636; 210/650; 210/797

(57) ABSTRACT

A method of cleaning filtering membranes with a cleaning chemical includes steps to partially or completely purge and refresh the cleaning chemical in an area at or near the membrane surface or in or near the membrane pores. A liquid cleaning chemical is provided in contact with a first side of the membranes. A portion of the cleaning chemical is moved towards a second side of the membranes by a transmembrane pressure. Some or all of the cleaning chemical in the pores of the membranes is purged by supplying a pressurized gas to the second side of the membranes. An amount of fresh cleaning chemical is then moved towards the first side of the membrane. Additional steps of purging and refreshing chemical cleaner may be performed.

This is an application claiming the benefit under 35 USC 119(e) of U.S. application Ser. No. 60/673,763, filed Apr. 22, 2005. application Ser. No. 60/673,673 is incorporated herein, in its entirety, by this reference to it for the benefit of its disclosure, although the invention described in this document is not limited by any statements in the incorporated document.

### FIELD OF THE INVENTION

This invention relates to an apparatus or process for cleaning ultrafiltration or microfiltration membranes with a cleaning chemical.

### BACKGROUND OF THE INVENTION

Membranes are used for separating a permeate lean in solids from a feed water rich in solids. Typically, one or more membranes have a retentate side in fluid communication with the feed water and a permeate side at which permeate is collected. Filtered feed water permeates through the walls of the membranes under the influence of a transmembrane pressure differential between the retentate side of the membranes and the permeate side of the membranes. Solids in the feed water are rejected by the membranes and remain on the retentate side of the membranes. The solids may be present in the feed water in solution, in suspension or as precipitates and may further include a variety of substances, some not actually solid, including colloids, microorganisms, exopolymeric substances excreted by microorganisms, suspended solids, and poorly dissolved organic or inorganic compounds such as salts, emulsions, proteins, humic acids, and others.

Over time, the solids foul the membranes which decreases their permeability. As the permeability of membranes decreases, the yield of the process similarly decreases or a higher transmembrane pressure is required to sustain the same yield. To prevent the decreased yield of the process or the increased transmembrane pressure from becoming unacceptable, the membranes must be cleaned. The cleaning may restore a portion of the permeability of the membranes or inhibit fouling of the membranes. Various methods of cleaning membranes are described in U.S. application Ser. No. 09/916,247. Various chemical cleaners are described in U.S. application Ser. No. 60/687,892, filed Jun. 7, 2005. U.S. application Nos. 09/916,247 and 60/687,892 are incorporated herein, in their entirety, by this reference to them for the benefit of their disclosure although the invention claimed in this document is not limited by any statements in the incorporated documents.

### SUMMARY OF THE INVENTION

This specification describes a method or apparatus for cleaning filtering membranes. This specification also describes a method of refreshing cleaning chemicals in or near the surface or pores of the membrane during chemical cleaning. Inventions may reside in various combinations or sub-combinations of elements or steps described in this summary or in other parts of this document, for example the figures or detailed description. This summary is intended to introduce the reader to the specification but not to define any invention. The invention or inventions protected by this document are defined in the claims.

A method for cleaning membranes with a chemical cleaner may comprise cleaning events started before the membranes foul significantly and may be repeated between once a week to one or more times per day. The product of the concentration of the chemical cleaner expressed as an equivalent concentration of NaOCl and the duration of all cleaning events may be between 2,000 minutes·mg/L and 30,000 minutes·mg/L per week. Each cleaning event may increase the permeability of the membranes by 10% or less.

A method having cleaning events as described above may be performed between recovery cleanings, that is cleanings with a CT greater than a cleaning event as described above, for example 50% or 100% greater, separated by intervals of 15 days or longer or 30 days or longer. The cleaning events may be performed between the recovery cleanings and the permeability of the membranes may decline between the recovery cleanings despite the cleaning events. The recovery cleanings may increase the permeability of the membranes, for example by 20% or more. The recovery cleanings may involve a product of concentration of a chemical cleaner expressed as an equivalent concentration of NaOCl and the duration of the recovery cleaning of 40,000 minutes·mg/L or more or 50,000 minutes·mg/L or more.

A method of cleaning filtering membranes with a cleaning chemical includes steps to refresh the cleaning chemical in an area at or near the membrane surface or in or near the membrane pores. A liquid cleaning chemical is provided in contact with a first side of the membranes, for example an outside surface of the membranes. A portion of the cleaning chemical is moved towards a second side of the membranes, for example the insides of the membranes, or into the membrane pores, or into a cavity defined by the second sides of the membranes, for example by applying a transmembrane pressure or venting the cavity or the second sides of the membranes. After a waiting period, some or all of the cleaning chemical is purged from the membrane pores, for example by supplying a pressurized gas to the second side of the membranes or to the cavity defined by the second side of the membranes. The pressurized gas may move the cleaning chemical out of the pores, for example by replacing cleaning chemicals previously in the pores with cleaning chemicals from the cavity. An amount of fresh cleaning chemical is then moved towards the second side of the membrane. Additional steps of purging and moving chemical cleaner may be performed. The method may be used to provide cleaning events as described above, or to provide recovery cleaning, or both.

### BRIEF DESCRIPTION OF THE DRAWINGS

Preferred embodiments of the invention will now be described with reference to the following figure or figures.

FIG. 1 is a schematic diagram of an embodiment of the invention.

### DETAILED DESCRIPTION OF THE INVENTION

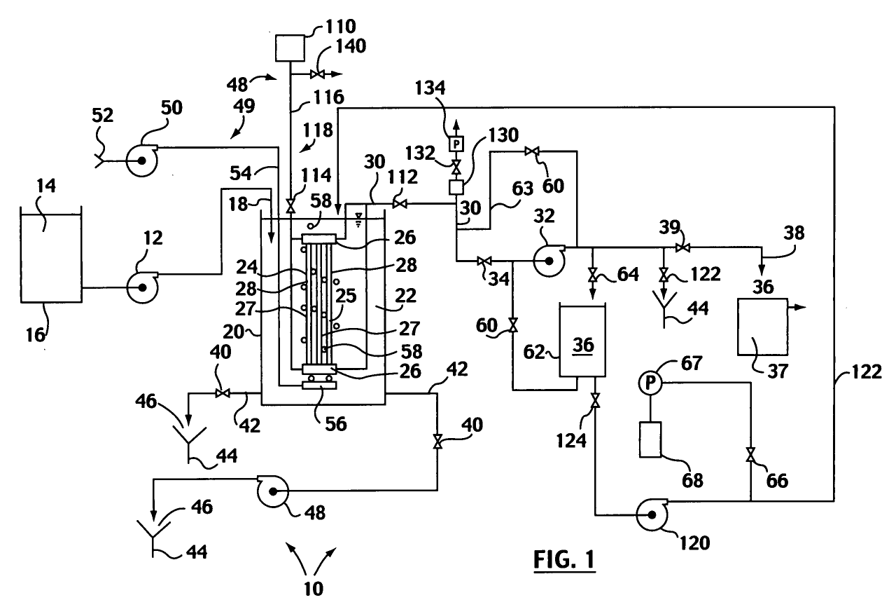

Referring now to FIG. 1, a reactor 10 is shown for treating a liquid feed having solids to produce a filtered permeate having a reduced concentration of solids and a retentate having an increased concentration of solids. Such a reactor 10 has many applications but will be described below as used for creating potable water from a natural supply of water such as a lake, well or reservoir or for separating clean water from mixed liquor in a waste water treatment plant.

The reactor 10 includes a feed pump 12 which pumps feed water 14, for example surface water, well water or waste water to be treated from a water supply 16, for example a reservoir or an upstream part of a waste water plant, through an inlet 18 to a tank 20 where it becomes tank water 22. If the process is being used for waste water treatment, tank water 22 may be referred to as mixed liquor and retained mixed liquor may be recycled, in whole or in part, to other parts of a treatment plant rather than being drained as will be described below. In this description, tank water 22 refers to both tank water 22 intended to be filtered for drinking, for example in dead end filtration, and mixed liquor or water to be filtered under a process including recycle to another tank. During permeation, the tank water 22 is maintained at a level which covers one or more membranes 24. Each membrane 24 has a permeate side 25 which does not contact tank water 22 and a retentate side 27 which does contact the tank water 22.

Membranes 24 made of hollow fibres are preferred for their ability to provide a high surface area and withstand backwash pressures although the membranes 24 may be of various other types such as tubular, ceramic, or flat sheet membranes. The membranes 24 may be oriented vertically or horizontally. Typically, headers 26, which may alternately be called potting heads or tube sheets, connect a plurality of hollow fibre or tubular membranes 24 together. The headers 26 seal the ends of the membranes 24 and either just one or both of the headers 26 connect the permeate sides 25 of the membranes 24 to appropriate piping. Similarly, flat sheet membranes are typically attached to headers or casings that create an enclosed surface on one side of a membrane or membranes and allow appropriate piping to be connected to the interior of the enclosed surface. A header 26 or casing holding one or more membranes may be referred to as a module. A plurality of modules may also be joined together and may be referred to as a cassette, cluster or other similar terms. In this description, however, the words “membrane” and “membranes” may be used to refer to one or more membranes 24 whether or not they are connected in one or more modules, cassettes or other structures.

Referring still to FIG. 1, for hollow fibre membranes 24, the retentate side 27 of the membranes 24 may be the outside of the membranes and the permeate side 25 of the membranes 24 may be their lumens. The permeate sides 25 of the membranes 24 are held in fluid communication with one or both of the headers 26 and together form a membrane module 28 which is connected to a permeate collector 30 and a permeate pump 32 through a permeate valve 34. When permeate pump 32 is operated and permeate valve 34 and an outlet valve 39 opened, a negative pressure is created in the permeate side 25 of the membranes 24 relative to the tank water 22 surrounding the membranes 24. The resulting transmembrane pressure draws tank water 22 through membranes 24 while the membranes 24 reject solids which remain in the tank water 22. Thus, filtered permeate 36 is produced for use at a permeate outlet 38. The transmembrane pressure could alternately be created by pressurizing the tank water 22. The transmembrane pressure may also be provided in the opposite direction, that is towards the outsides of the membranes 24 with the feed provided to the insides of the membranes 24.

The filtered permeate 36 may require post treatment before being used as drinking or process water or discharged at the end of a wastewater treatment process, but should have acceptable levels of solids. Preferably, the membranes 24 have an average pore size between 0.003 microns and 10 microns and more preferably between 0.02 microns and 1 micron. Suitable membranes include those sold under the ZEEWEED trade mark and produced by Zenon Environmental Inc., for example ZEEWEED 500 or ZEEWEED 1000 membrane products. The total size and number of membranes 24 required varies for different applications depending on factors such as the amount of filtered permeate 36 required and the condition of the feed water 14. Similarly, the preferred transmembrane pressure to be applied to the membranes 24 varies for different membranes and the desired yield but typically ranges from 1 kPa to 100 kPa and preferably is less than 67 kPa for ZEEWEED hollow fibre membranes 24.

Tank water 22 which does not flow out of the tank 20 through the permeate outlet 38 flows out of the tank 20 through a drain valve 40 in a retentate outlet 42 to a drain 44 as retentate 46. Alternately, or additionally, retentate 46 may travel through retentate outlet 42 to another downstream treatment area or be recycled to water supply 16 or another upstream treatment area. The retentate 46 is rich in the solids rejected by the membranes 24. When producing potable water, the retentate 46 may be sent back to the source that the feed water 14 was originally drawn from. In waste water treatment applications, some of the retentate 46 may be a sludge which is further processed, for example by recycle to the head of the plant, while another part of the retentate 46 is a waste sludge that is disposed of, possibly after thickening or other operations. In drinking water applications, the retentate 46 may be withdrawn from the tank 20 either continuously or periodically. In wastewater applications, the reactor 10 may be operated continuously. In continuous operation, alternately called feed and bleed, although there may be short periodic interruptions for example for cleaning, maintenance or integrity testing procedures, feed water 14 flows into the tank 20 and permeate 36 is withdrawn from the tank over extended periods of time and retentate 46 is withdrawn generally continuously as needed to preserve the required level of tank water 22 in the tank 20. In periodic operation, filtering may occur in a batch mode, or with periods of dead end filtration without retentate 46 withdrawal separated by deconcentration procedures involving draining the tank 20 of retentate 46 and refilling it with new feed water 14. In some drinking water applications, the process operates continuously but for periodic, i.e. once a day, tank drainings for cleaning, maintenance or integrity testing procedures. Other processes may also be used.

During permeation, a permeate tank valve 64 may be opened from time to time to provide permeate 36 in a permeate recycle tank 62. The remainder of the permeate 36 is produced for use or discharge. During permeation, solids accumulate on the surface of the membranes 24 and in their pores, fouling the membranes 24. Various techniques may prevent some of this fouling. Firstly, the membranes 24 may be agitated, for example by mechanically agitating the tank water 22 near the membranes 24 or by supplying a gas to the tank water 22 near the membranes 24. For this, a gas supply system 49 has an gas supply pump 50 which blows a gas, for example ambient air, from an intake 52 through gas distribution pipes 54 to an aerator 56 which disperses gas bubbles 58 into the tank water 22 near the membranes 24. The gas bubbles 58 may be provided continuously or intermittently, and during permeation, backwash or relaxation periods to discourage solids from depositing on the membranes 24. Secondly, backwashing may be used. For this, the membranes 24 are backwashed by closing permeate valve 34 and outlet valve 39 and opening backwash valves 60. Permeate pump 32 draws filtered permeate 36 from the permeate recycle tank 62 and flows permeate 36 through a backwash pipe 63 to the headers 26 and through the walls of the membranes 24 in a reversed direction thus pushing away some of the solids attached to the membranes 24. At the end of the backwash, backwash valves 60 are closed and permeate valve 34 re-opened. Permeate pump 32 may flow permeate 36 back into permeate recycle tank 62 until permeate recycle tank 62 is refilled. Permeate tank valve 64 may be then closed and outlet valve 39 opened. Such backwashing may occur approximately every 15 minutes to 90 minutes for a period of 15 seconds to one minute. Although permeation is temporarily disrupted and some permeate 36 returns to tank 20, a continuous process is still considered continuous and a dead end process is still considered dead end. Permeate 36 may pass through a permeate holding tank 37 to even out disruptions in the flow of permeate 36. Air entrained in the permeate 36 may be collected in an air collector 130 connected to a high point in the permeate lines 30. To remove collected air, an air collector valve 132 may be opened and a vacuum pump 134 operated as required to discharge air collected in the air collector 130.

With backwashing and the use of gas bubbles 58 to clean the membranes 24, permeation may continue for 1 or 2 weeks or more before the permeability of the membranes 24 drops to the point where recovery cleaning would normally be required.

An embodiment of the present invention, to be described below, is directed at reducing the rate of loss of permeability of the membranes 24 so that the time between recovery cleanings can be lengthened, for example to 15 days or more or 30 days or more, or the intensity of recovery cleanings may be reduced. This strategy is referred to generally as maintenance cleaning. Optionally, in addition to backwashing and gas scouring or agitation, cleaning events are performed generally periodically at a frequency preferably ranging from one or more times per day to once a week, for example between 2 and 4 times per week. The cleaning events are started before there is significant fouling of fresh membranes 24, for example while permeability is still above 70% of the permeability of the membranes 24 when fresh, and more preferably within a week of when permeation is started with fresh membranes. Fresh membranes 24 may be new membranes 24 or membranes 24 that have just been through recovery cleaning. The cleaning events may each increase the permeability of the membranes by only 10% or less and permeability of the membranes 24 may decline, although at a reduced rate, between recovery cleanings despite the cleaning events. However, the intensity or frequency of recovery cleaning can be reduced. For example, recovery cleaning may be provided once every 15 days or longer or once every 30 days or longer. A recovery cleaning may increase permeability of the membranes by 20% or more.

The cleaning events, the recovery cleanings, or both involve contacting the membranes 24 with a chemical cleaner while ordinary permeation is stopped according to a method to be described below. The chemical cleaner used may be any chemical appropriate for the application and not overly harmful to the membranes 24. Typical chemicals include oxidants such as sodium hypochlorite, acids such as citric acid and bases such as sodium hydroxide. The chemical cleaner may be a liquid or may be used in a non-liquid form such as by introducing it as a solid into a volume or flow of water. Liquid chemical cleaners, however, may be easier to handle and inject in the proper amounts.

To contact the membranes 24 with chemical cleaner, permeate valve 34, outlet valve 39 and backwash valves 60 are all closed and permeate pump 32 turned off. The tank water 22 is drained from the tank 20 and the drain valves 40 are closed. Permeate fill pump 120 is operated with permeate fill valve 124 open to flow permeate 36 from permeate recycle tank 62 through permeate fill line 122 to tank 20. Chemical valve 66 is opened and chemical pump 67 turned on pushing chemical cleaner from chemical tank 68 into permeate fill line 122 to mix cleaning chemicals into the permeate 36 flowing to the tank 20. Alternately, cleaning chemicals can be pumped from a chemical tank 68 holding a larger volume of a more dilute cleaning chemical directly into tank 20. When tank 20 is full with a solution of cleaning chemicals and water, permeate fill pump 120 is stopped and permeate fill valve 124 is closed. Sometime between stopping permeation and when the chemical clearer has been added to tank 20, pressurized air valve 114 is opened to allow pressurized air source 110 to deliver pressurized air through pressurized air line 116 to one or both headers 26. This purges some or all of the cleaning chemical from the lumens of the membranes 24 and optionally some or all of the pores of the membranes 24. During this time, shut off valve 112 is closed. The pressurized air source 110 may be a pump, blower, compressed air tank or other device able to provide a flow of pressurized air or another gas. Pressurized air source 110, and also pressurized air line 116 and valve 114, may also be part of a membrane integrity testing system 118 used to provide air under pressure to the one side of the membranes 24 during integrity tests, for example a pressure decay test. A vent valve 140 may be opened to vent the pressurized air line 116 to expose the lumens of the membranes 24 to ambient pressure. The integrity testing system may provide air at a pressure normally used for integrity testing, for example about 15 psi, or may be modified with a pressure control mechanism to provide air at a lower pressure, for example 10 psi or less, or about 5 psi. Similar pressures may also be provided using other devices. This first purge as described above may be performed before the tank 20 is drained. This prevents dilution of the cleaning chemicals with permeate pushed into the tank during the purge. Further, if the chemical cleaner is optionally heated, performing a first purge before draining the tank 20 and re-filling the tank 20 with cleaning chemical avoids cooling of the cleaning chemical by the purged permeate. Alternately, however, the first purge can be performed after the tank 20 has been drained and partially re-filled with cleaning chemical. The purged permeate is then intentionally used to complete re-filling the tank and bring the cleaning chemical down to a desired concentration.

The pressurized air moves fluids away from or out of the lumens or permeate sides 25 of the membranes 24. After a period of time, pressurized air valve 114 is closed. Shut off valve 112, permeate valve 34 and diversion valve 122 are then opened. Permeate pump 32 is operated for a short time to move cleaning chemical from the tank 20 into the pores of the membranes 24 and then stopped. Alternately, vent valve 140 can be opened to vent the lumens of the membranes 24 and allow chemical cleaner to flow into the pores and lumens of the membranes 24. Further optionally, shut off valve 112 may be opened but permeate valve 34 and diversion valve 122 left closed. Vacuum pump 134 of the air removal system may then be operated, as required, to move cleaning chemical from the tank 20 into the pores of the membranes 24. Pressurized air may then be applied to the permeate sides 25 or lumens of the membranes 24 again, as described above, optionally after a waiting period, to move reacted cleaning chemical out of the pores of the membranes 24. The reacted chemical cleaner moved out of the pores of the membranes may be displaced by chemical cleaner from within the lumens of the membranes 24 which may occupy the pores of the membranes 24 until the following steps. Fresh cleaning chemical is then drawn back into the pores of the membranes 24 by venting or using suction by operating the permeate pump 32 or vacuum pump 134 as described above to refresh the cleaning chemical in the pores of the membranes. The steps of moving chemical cleaner into the pores, alternately called a refresh step, and then moving chemical cleaner out of the pores, alternately called a purge step, may be repeated several times. Optionally, a waiting step may be added between the refresh step and the purge step to allow refreshed cleaning chemical more time to react with foulants. It is optional, but not necessary, to fully purge the pores of the membranes 24 of reacted cleaning chemical and provide fresh, unreacted cleaning chemical with each repetition of these steps. The objective is to exchange at least some cleaning chemical that has been reacting with solids or other foulants on the surfaces of the membranes 24 or in their pores with fresh cleaning chemical and/or remove reaction products from near the membranes. In this way, the average concentration of the cleaning chemical over the entire duration of a procedure may be higher than if, for example, the tank 20 or pores of the membranes 24 were filled with cleaning chemical and then simply allowed to soak for some length of time. Further, the purge steps may also provide some physical removal of foulants. The waiting periods between a refresh step and a following purge step, if any, may be 30 seconds or longer, for example between 1 and 6 minutes. Alternately, the process may be generally continuous with refresh and purge steps performed generally right after each other, for example, with a delay between subsequent steps of only long enough to complete and verify valve movements or to provide a safety factor to ensure that purge and refresh steps do not overlap.

During the cleaning procedure, or during the purge and refresh steps of the cleaning procedure, agitation, such as air scouring, may be provided in the tank water 11. This helps disperse partially reacted cleaning chemical being purged from the membranes 24 and bring more nearly unreacted cleaning chemical to the outsides of the membranes 24 to be drawn into the pores during the refresh step. After the desired number of purge, refresh and wait steps have been performed, the tank 20 may be drained of the chemical cleaner and refilled with fresh feed water. The drained chemical cleaner may be neutralized and discarded or reused. The concentration of the cleaning chemical may be increased before reuse by concentration or by adding new chemical. Permeate initially produced after returning the membranes 24 to service may be diverted to a drain 44 or to another post treatment or recycling area by allowing permeate outlet valve 39 to be closed and permeate diversion valve 122 to be open for a time until cleaning chemical on the permeate side of the membranes 24 has been removed from the permeate lines 30. The membranes 24 may optionally be backwashed before returning them to service, optionally before draining the tank 20 of chemical cleaner. The backwash may remove cleaning chemical from the permeate sides 25 of the membranes 24 and may also dislodge deposits of solids weakened by the cleaning chemicals.

With the method of flowing chemical cleaner to the tank 20 described above, the chemical cleaner is diluted before reaching the membranes 24. In the following discussion, the concentration of the chemical cleaner is measured or approximated to be the concentration in the pores of the membranes 24 rather than in the chemical tank 68 unless stated otherwise. This concentration will be referred to as “C”.

The effectiveness of the chemical cleaner is dependant on the concentration of the chemical cleaner and the time that the chemical cleaner remains against the side, for example the retentate side 27, or in the pores of the membranes 24. For process calculations, the concentration of the chemical cleaner in the pores of the membranes 24 may be modeled or calculated based on the initial concentration of the chemical cleaner in the tank 20 and its rate of reaction with the solids or foulants. However, if the cleaning chemical is substantially purged and refreshed at least every 6 minutes, the concentration “C” is assumed to be the same as the concentration of the chemical cleaner in the tank 20. Cleaning chemicals may be added to the tank 20 over the course of a cleaning procedure to maintain a generally constant concentration in the tank 20 or the concentration in the tank 20 may be allowed to decline over the course of a cleaning procedure as the chemicals react with the solids. If the change in the concentration of cleaning chemicals in the tank 10 is less than about 30% of the initial concentration over the course of a cleaning event, then the concentration “C”for calculation purposes may be assumed to be the initial concentration.

The time during which the chemical cleaner is applied to the membranes 24 will be called “T”. Provided that a step of moving cleaning chemical into the pores of the membranes 24 is performed within 5 minutes of the end of an initial step of adding cleaning chemical to the tank 20, and that the tank 20 starts to be drained within 5 minutes of a last step of moving cleaning chemical into the pores of the membranes 24, T is assumed to be the time between when the cleaning chemical has initially been added to the tank 20 and the time when the tank 20 starts to be drained of the cleaning chemical. In general, T is assumed for calculations to be the time between the first and last step of moving cleaning chemical into the pores of the membranes 24, plus (a) the lesser of 5 minutes and the time between when the chemical cleaner has been initially added to the tank 20 and a first step of moving cleaning chemical into the pores of the membranes 24, and (b) the lesser of 5 minutes and the time between the last step of moving cleaning chemical into the pores of the membranes 24 and the tank 20 starting to be drained.

The effectiveness of a cleaning procedure is approximated by multiplying the C and T parameters to create a third parameter “CT”. Since the cleaning events may be repeated with varying frequency for different applications or concentrations of solids in the feed water 14, a parameter called the weekly CT is used as a basis for some calculations. The weekly CT is the sum of the CT parameters for the cleaning events performed during a week. If cleaning events are performed less frequently than once a week, a monthly CT parameter can be used instead with appropriate modifications to the calculations which depend on the weekly CT parameter.

The desired weekly CT may be chosen to maintain acceptable permeability of the membranes 24 or to reduce a rate of decline in permeability of membranes 24 over extended periods of time, for example between 15 days and three months or longer, so as to reduce the frequency of recovery cleanings rather than to provide recovery cleaning itself. In some drinking water applications, however, recovery cleanings can be postponed for very long periods of time, for example 6 months to a year. There may be a slight instantaneous increase in permeability of the membranes 24 after a cleaning event, for example of 10% or less, but this permeability gain is typically lost before the next cleaning event and is not significant enough to be considered recovery cleaning. Recovery cleanings may increase the permeability of the membranes by 20% or more.

The weekly CT may be in the range of 2,000 min·mg/l to 30,000 min·mg/l when NaOCl is the chemical cleaner. For drinking water applications, the weekly CT may be between 5,000 min·mg/l and 10,000 min·mg/l of NaOCl. For waste water applications, the weekly CT may be between 10,000 min·mg/l and 30,000 min·mg/l of NaOCl. When other chemical cleaners are used, the concentration of the chemical cleaner is expressed as an equivalent concentration of NaOCl that has similar cleaning efficacy. For example, for citric acid, preferred values are approximately 20 times those given for NaOCl and for hydrochloric acid, preferred values are approximately 4 times the values given for NaOCl. The precise weekly CT to use in a given application is preferably chosen to achieve a gradual decline in permeability over an extended period of time between recovery cleanings. The recovery cleaning may be performed less frequently, for example once every 15 days, or once a month or every three months or more. The recovery cleanings may be provided using the method of contacting the membranes 24 with cleaning chemicals described above. However, a recovery cleaning is more intensive than a cleaning event. For example, a single recovery cleaning may have a CT of 40,000 min·mg/l or more or 50,000 min·mg/l or more of NaOCl, or of another chemical when expressed as an equivalent concentration of NaOCl.

For a given weekly CT, the weekly duration of cleaning events is calculated by dividing the weekly CT by the concentration, C, of chemical cleaner in the tank 20. For NaOCl, a C between 20 mg/l and 200 mg/l may be used. Once the total weekly duration of cleaning events is known, the frequency of cleaning events is next determined. Frequent cleaning events may be more effective and provide less variation in permeability of the membranes 24 over time but require more frequent disruptions to permeation and may increase the volume of cleaning chemical to be disposed of or otherwise handled. Cleaning events may be performed, for example, between 1 and 7 times per week or between 2 and 4 times per week. The duration, T, of each cleaning event is then determined by dividing the weekly duration of cleaning events by the number of times per week that cleaning events are performed. T may range, for example, from 10 to 100 minutes or from 30 minutes to 60 minutes, for example 30 minutes for drinking water applications and 60 minutes for wastewater applications.

The waiting period between each suction step and a following purge, if any, may be as long as, for example, between 50 seconds and 6 minutes or about 3 minutes for drinking water applications and about 5 minutes for wastewater applications. The cleaning chemical may be refreshed between 2 and 100 or between 5 and 30 times during a cleaning event and possibly a greater number of times during recovery cleaning.

It is to be understood that what has been described are preferred embodiments to the invention. The invention nonetheless is susceptible to changes and alternative embodiments without departing from the invention.

We claim:

1. A process for cleaning a membrane, the membrane having a first side and a second side separated by a wall having pores, the process comprising the steps of,
a) providing a volume of a cleaning chemical solution in contact with the first side of the membrane;
b) after step a) applying a transmembrane pressure towards the second side of the membrane to move a portion of the cleaning chemical solution into the pores of the membrane;
c) after step b), applying a pressurized gas to the second side of the membrane to move a portion of the cleaning chemical solution in the pores of the membrane out of the pores of the membrane; and,
d) repeating steps b) and c) at least once each.

2. The process of claim 1 wherein each step c) is performed at least 30 seconds after a preceding step b).

3. The process of claim 2 wherein each step c) is performed between one minute and six minutes after a preceding step b).

4. The process of claim 1 wherein steps b) and c) are repeated at least 2 times each.

5. The process of claim 1 wherein the pores of the membranes are substantially filled with cleaning chemical solution during step b).

6. The process of claim 5 wherein the cleaning chemical solution is substantially purged from the pores of the membrane during step c).

7. The process of claim 1 wherein the volume of cleaning chemical solution is provided in contact with the first side of the membrane by providing a cleaning chemical solution in a tank containing the membrane.

8. The process of claim 1 wherein the first side of the membrane is an outside and retentate side of the membrane.

9. The process of claim 1 wherein the transmembrane pressure is applied by applying suction to the second side of the membrane.

10. The process of claim 9 wherein the application of the transmembrane pressure is insufficient to draw cleaning chemical to the inlet of the permeate pump.

11. The process of claim 1 wherein, in step (c), the cleaning chemical solution in the pores of the membranes is replaced by cleaning chemical solution from within a cavity defined by the second side of the membranes.

12. The process of claim 11 wherein the membranes are hollow fibers and the cavity comprises lumens of the hollow fibers.

13. The process of claim 1 further comprising draining a tank containing the membranes before step (a).

14. The process of claim 1 further comprising purging the membranes before step (a).

15. The process of claim 1 wherein consecutive performances of steps (b) and (c) are performed generally right after each other.

16. A cyclical process for filtering water with a membrane comprising the steps of,
a) withdrawing permeate from a membrane immersed in a tank of feed water,
b) after step a) putting a cleaning chemical in the tank;
c) after step b) applying a transmembrane pressure towards the inside of the membrane to move a portion of the cleaning chemical into the pores of the membrane;
d) after step c), applying a pressurized gas to the insides of the membrane to move a portion of the cleaning chemical in the pores of the membrane back out of the pores of the membrane;
e) repeating steps c) and d) ate least once each;
f) after step e), removing the cleaning chemical from the tank;
g) after step f), refilling the tank with feed water; and,
h) returning to step a).

17. The process of claim 16 further comprising a step of backwashing the membranes after step e) but before step h).

18. The process of claim 16 further comprising a step of removing air from the insides of the membranes after step e).

19. The process of claim 16 wherein, step (d), cleaning chemical in the pores of the membrane is replaced by cleaning chemical from the inside of the membrane.

20. The process of claim 19 wherein the membrane is a hollow fiber membrane and the inside of the membrane is its lumen.
